(19) United States
(12) Patent Application Publication
(10) Pub. No.: US 2002/0129958 A1
(43) Pub. Date: Sep. 19, 2002

(54) Cushioned grommet strip with exposed end

(76) Inventor: Hector D. Petri, Framingham, MA (US)

Correspondence Address: JOHN E. TOUPAL, 116 CONCORD STREET, FRAMINGHAM, MA, 01701

(21) Appl. No.: 09/810,050

(22) Filed: Mar. 19, 2001

(51) Int. Cl. H02G 3/18

(52) U.S. Cl. 174/65 G

(57) ABSTRACT

A grommet strip for mounting along an exposed edge of an opening in a wall and including a spring tempered metal strip having a predetermined length L and comprising an elongated base portion and a plurality of discrete spaced apart finger portions extending in a common direction from each longitudinal edge of the base portion and substantially normal thereto, inner surfaces of the base and finger portions forming a first elongated channel with an open end opposite to the base portion and arranged to receive the edge of the wall with the inner surface of the base portion engaging the exposed edge and the inner surfaces of the finger portions engaging marginal sections of the wall directly adjacent thereto; a resilient non metallic coating covering outer surface portions of the base and finger portions; and a resilient cushion strip having a given length substantially less than L, and defining a second elongated channel, the resilient cushion strip retaining the elongated base portion in the second elongated channel.

### BACKGROUND OF THE INVENTION

This invention relates generally to a grommet strip for covering an exposed edge of a wall and, more particularly, to an electrically insulating grommet strip for covering the exposed edges of openings in electrical equipment housings.

Electrical equipment housings frequently possess openings for the passage of electrical wires. Generally, such openings are equipped with grommets or bushings that cover and insulate the exposed edges of the openings. A common grommet is made of rubber or a similar resilient material and consists of a pair of annular spaced apart flange portions internally joined by a cylindrical portion. The cylindrical portion projects through an opening and the flange portions engage the peripheral wall portions thereof. Disadvantages of such grommets include the requirement for large inventories to accommodate openings of various size, and their inapplicability to openings of other than circular shape. Other known grommets require the cumbersome and time consuming use of adhesives.

An improved grommet strip that does not require the use of adhesives for installation is disclosed in U.S. Pat. No. 5,975,177. Although satisfactory for many applications, the grommet strip disclosed in that patent does have disadvantages in certain applications. For example, when used in certain applications a small gap can occur between the ends of an installed grommet strip. Such a gap generally is filled with a suitable epoxy cured with infra-red energy. However, the gap filling procedure is both time consuming and costly.

The object of this invention, therefore, is to provide an improved grommet for covering the exposed edges of openings in electrical housings.

### SUMMARY OF THE INVENTION

The invention is a grommet strip for mounting along an exposed edge of an opening in a wall and including a spring tempered metal strip having a predetermined length L and comprising an elongated base portion and a plurality of discrete spaced apart finger portions extending in a common direction from each longitudinal edge of the base portion and substantially normal thereto, inner surfaces of the base and finger portions forming a first elongated channel with an open end opposite to the base portion and arranged to receive the edge of the wall with the inner surface of the base portion engaging the exposed edge and the inner surfaces of the finger portions engaging marginal sections of the wall directly adjacent thereto; a resilient non metallic coating covering outer surface portions of the base and finger portions; and a resilient cushion strip having a given length substantially less than L, and defining a second elongated channel, the resilient cushion strip retaining the elongated base portion in the second elongated channel. The provision of a shortened cushion strip allows the metal strip to overlap and thereby close tightly around the opening.

According to features of the invention, the resilient cushion strip extends from one end of the spring tempered metal strip to a point spaced from an opposite thereof by a length L preferably less than 5% of L. These features allow complete lining of the opening with a slightly overlapped grommet strip.

According to another feature of the invention, the finger portions extending from one of the edges are longitudinally displaced with respect to the finger portions extending from the other edge so as to be transversely non aligned therewith. The non-aligned finger portions enhance flexibility of the grommet strip.

The invention also encompasses a method of producing a grommet strip having a spring tempered metal strip with a predetermined length L and including an elongated base portion and a plurality of discrete spaced apart finger portions extending in a common direction from each longitudinal edge of said base portion and substantially normal thereto with inner surfaces of the base and finger portions forming a first elongated channel; a resilient non metallic coating covering outer surface portions of the base and finger portions; and a resilient cushion strip having a given length substantially less than L, and defining a second elongated channel retaining the elongated base portion. The method includes the steps of stamping the metal strip out of a blank; forming the strip to provide the first channel; providing the cushion strip; and combining the cushion strip and metal strip so as to provide the spacing of the cushion strip from the opposite end of the metal strip. The method provides a grommet strip which can be overlapped to completely cover the edge of an opening.

The invention further encompasses a method of securing a grommet strip to an exposed edge of an opening in a wall, the grommet strip having a spring tempered metal strip with a predetermined length L and including an elongated base portion and a plurality of discrete spaced apart finger portions extending in a common direction from each longitudinal edge of the base portion and substantially normal thereto such that inner surfaces of the base and finger portions form a first elongated channel; a resilient non metallic coating covering outer surface portions of the base and finger portions; a resilient cushion strip having a given length substantially less than L, and defining a second elongated channel retaining the elongated base portion and extending from one end of said spring tempered metal strip to a point spaced from an opposite end thereof by a length L.

### DESCRIPTION OF THE DRAWINGS

These and other objects and features of the invention will become more apparent upon a perusal of the following description taken in conjunction with the accompanying drawings wherein:

FIG. 1 is an elevational view of a grommet strip component according to the invention;

FIG. 2 is a cross-sectional view taken along lines 2-2 in FIG. 1;

FIG. 3 is a perspective view of a cushion strip used in the apparatus;

FIG. 4 is a cross-sectional view taken along lines 4-4 in FIG. 3;

FIG. 5 is an elevational view of a composite strip formed with the strips shown in FIGS. 1-4;

FIG. 6 is an elevational view of a modified grommet strip according to the invention;

FIG. 6A is an elevational view of the strip of FIG. 6 with opposite ends juxtaposed prior to assembly in an opening;

FIG. 7 is a view of the strip of FIG. 6 shown mounted in a wall opening; and

FIG. 8 is a cross-sectional view taken along lines 8-8 of FIG. 7.

### DESCRIPTION OF THE PREFERRED EMBODIMENT

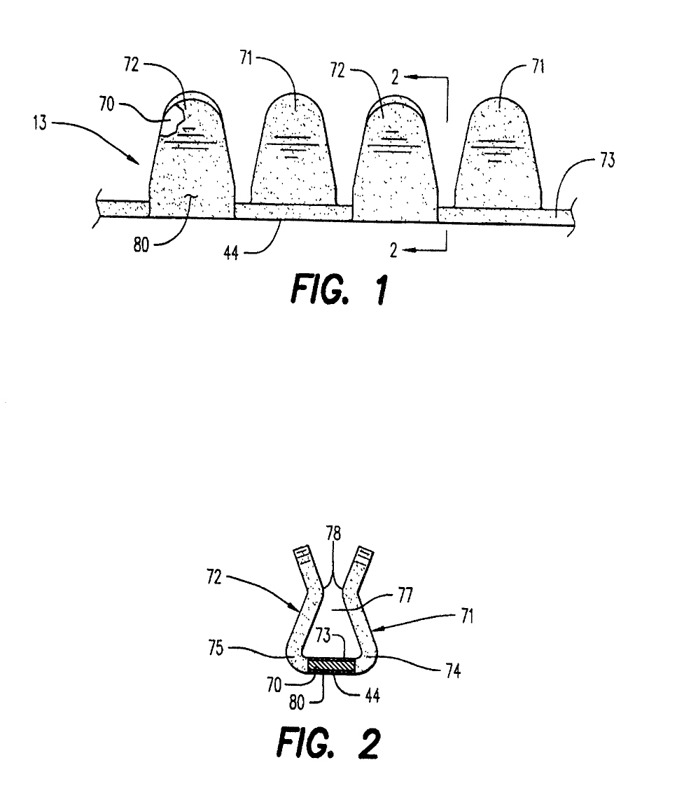

As illustrated in FIGS. 1 and 2, a U-shaped grommet strip 13 is a spring tempered metal stamping 70 having finger portions 71 extending orthogonally from one edge 74 of an elongated base strip 73 and finger portions 72 projecting orthogonally from an opposite edge 75 thereof. The finger portions 71 along the edge 74 are longitudinally spaced apart and alternate with the longitudinally spaced apart finger portions 72 along the edge 75. Together the base strip 73 and finger portions 71, 72 form a channel 77. Each of the finger portions 71, 72 has a V-shaped section with intermediate portions 78 projecting into the channel 77. After formation by a stamping and bending operation, the grommet strip 13 preferably is coated with a suitable, resilient, non-metallic coating 80 such as a thermo-setting or thermoplastic polymer. The coating 80 can be applied, for example, as an electrostatic spray and then fused to the metal strip 70 by exposure to heat in an oven.

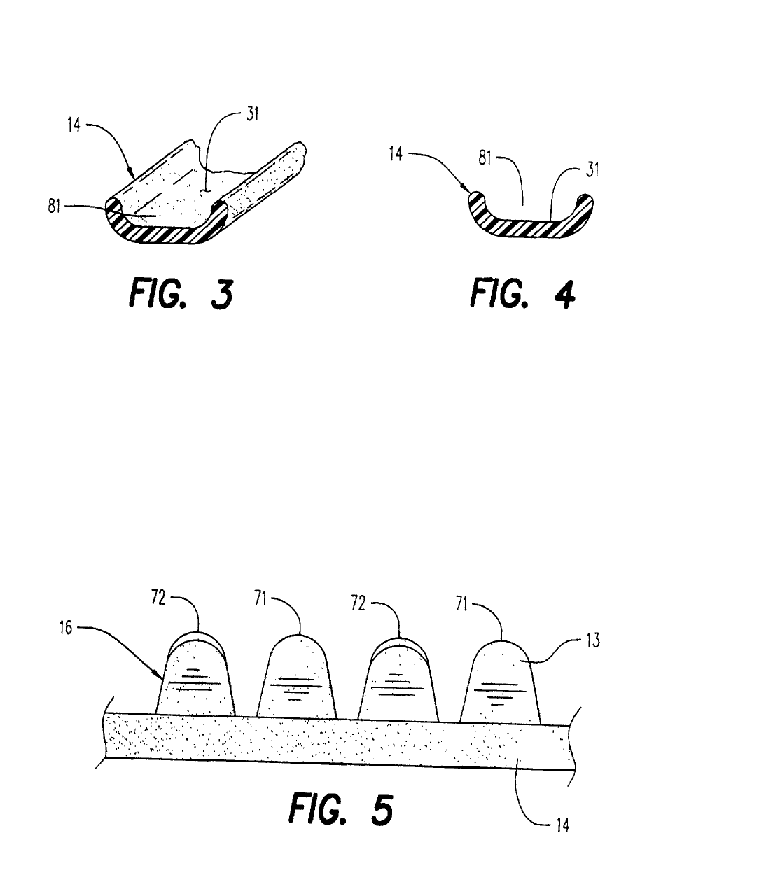

FIGS. 3 and 4 depict an elongated extrusion cushion strip 14 formed of a suitable polymer such as urethane. The strip 14 has a U-shaped cross-section so as to form a channel 81 having an inner bottom contact surface 31. After being longitudinally combined, the grommet strip 13 and cushion strip 14 form the composite strip 16 having the form depicted in FIG. 5. The channel 81 of the cushion strip 14 receives the elongated base strip 73 of the grommet strip 13 and the engagement surface 44 of the grommet strip 13 engages the contact surface 31 of the cushion strip 14 and is secured thereto by an adhesive. A method for forming the composite strip 16 is disclosed in U.S. Pat. No. 5,975,177.

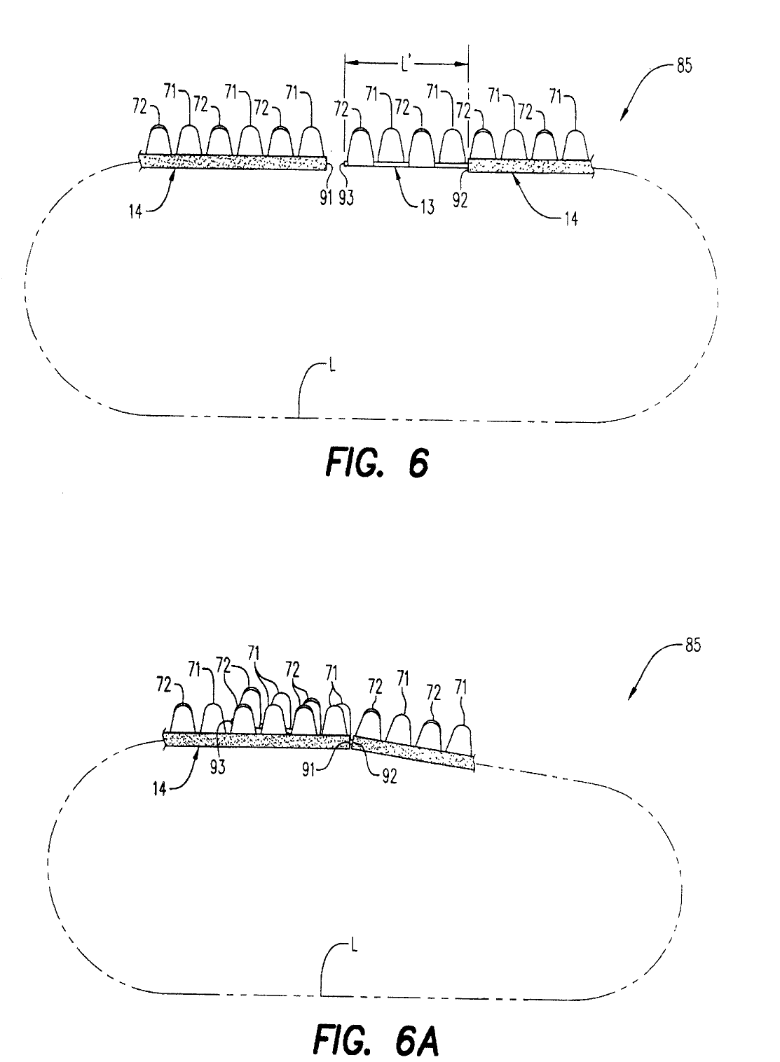

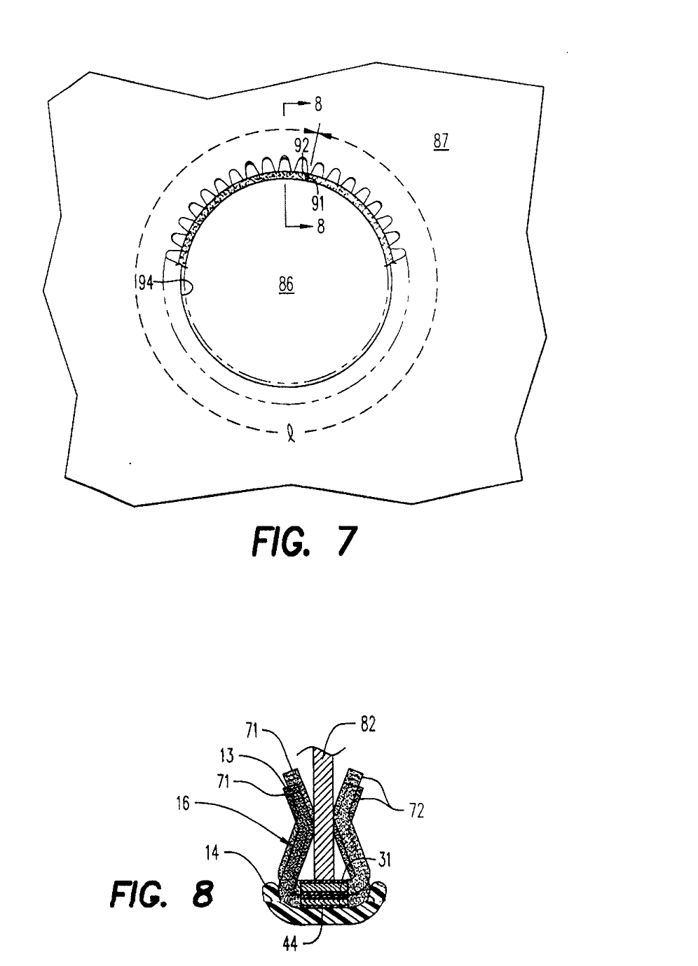

Once formed, the composite strip 16 is cut into individual strips each having a length accommodating a wall opening to be lined. For example, an individual strip 85 (FIG. 6) is cut to a predetermined circumference L slightly greater than the length of an opening 86 in a housing wall 87 (FIG. 7). A portion of cushion strip 14 then is removed leaving a reduced given length of the cushion strip 14 still attached to the metal strip 13 of length L. Alternatively, the individual strip 85 can be prepared by cutting, from the metal strip 13, a portion of length L before attachment of the cushion strip 14. The severed length L of metal strip 13 then is placed in a fixture (not shown) and the given length of cushion strip 14 secured to the metal strip with a suitable epoxy. In either case, the resultant composite strip 85 consists of a metal strip 13 of length L and a cushion strip 14 of length extending between one end 91 of the metal strip 13 to a point 93 spaced from an opposite end 92 by a length L. The length L is substantially less than length L and preferably less than 5% thereof.

As shown in FIG. 7, the prepared individual strip 85 is placed over an exposed edge 94 of the wall opening 86 with the base portion 73 overlaying the edge 94 and the finger portions 71, 72 engaging portions of the wall 85 adjacent to the edge 94. The length portion L of the strip 13 overlaps the one end 91 and extends into the elongated channel thereof. Thus, no gap in the applied grommet strip 85 exists along the edge 94.

Obviously, many modifications and variations of the present invention are possible in light of the above teachings. It is to be understood, therefore, that the invention can be practiced otherwise than as specifically described.

What is claimed is:

1. A grommet strip for mounting along an exposed edge of a wall and comprising:
a spring tempered metal strip having a predetermined length L and comprising an elongated base portion and a plurality of discrete spaced apart finger portions extending in a common direction from each longitudinal edge of said base portion and substantially normal thereto, inner surfaces of said base and finger portions forming a first elongated channel with an open end opposite to said base portion and adapted to receive the edge of the wall with said inner surface of said base portion engaging the exposed edge and said inner surfaces of said finger portions engaging marginal sections of the wall directly adjacent thereto;
a resilient non metallic coating covering outer surface portions of said base and finger portions; and
a resilient cushion strip having a given length substantially less than L, and defining a second elongated channel, said resilient cushion strip retaining said elongated base portion in said second elongated channel.

2. A grommet strip according to claim 1 wherein said resilient cushion strip extends from one end of said spring tempered metal strip to a point spaced from an opposite end thereof by a length L.

3. A grommet strip according to claim 2 wherein L is less than 5% of L.

4. A grommet strip according to claim 3 wherein said finger portions extending from one of said edges are longitudinally displaced with respect to said finger portions extending from the other of said edges so as to be transversely non aligned therewith.

5. A grommet strip according to claim 4 wherein each of said finger portions comprises a bottom edge fixed to one of said longitudinal edges, a top edge substantially shorter than said bottom edge, and side edges that project into said first elongated channel between said bottom and top edges.

6. A grommet strip according to claim 2 wherein said grommet strip has a uniform given height, and said cushion strip has a uniform predetermined height less than one-third (⅓) said given height.

7. A grommet strip according to claim 6 wherein said finger portions extending from one of said edges are longitudinally displaced with respect to said finger portions extending from the other of said edges so as to be transversely non aligned therewith.

8. A grommet strip according to claim 7 wherein each of said finger portions comprises a bottom edge fixed to one of said longitudinal edges a top edge substantially shorter than said bottom edge, and side edges that project into said first elongated channel between said bottom and top edges.

9. A method of producing a grommet strip having a spring tempered metal strip having a predetermined length L and comprising an elongated base portion and a plurality of discrete spaced apart finger portions extending in a common direction from each longitudinal edge of said base portion and substantially normal thereto, inner surfaces of said base and finger portions forming a first elongated channel with an open end opposite to said base portion and adapted to receive the edge of the wall with said inner surface of said base portion engaging the exposed edge and said inner surfaces of said finger portions engaging marginal sections of the wall directly adjacent thereto;
a resilient non metallic coating covering outer surface portions of said base and finger portions;
a resilient cushion strip having a given length substantially less than L, and defining a second elongated channel, said resilient cushion strip retaining said elongated base portion in said second elongated channel; said method comprising the steps of:
stamping said metal strip out of a blank;
forming said strip to provide said first channel;
providing said cushion strip; and
combining said cushion strip and said metal strip so as to provide said spacing of said cushion strip from said opposite end of said metal strip.

10. A method according to claim 9 including the step of cutting said metal strip to said length L.

11. A method according to claim 10 including the steps of cutting said cushion strip to said length, and securing said cut cushion strip to said metal strip.

12. A method according to claim 10 including the steps of securing said cushion strip to said metal strip, and removing a portion of said secured cushion strip to provide a remaining portion of said length.

13. A method of securing a grommet strip to an exposed edge of an opening in a wall, the grommet strip having a spring tempered metal strip having a predetermined length L and comprising an elongated base portion and a plurality of discrete spaced apart finger portions extending in a common direction from each longitudinal edge of said base portion and substantially normal thereto, inner surfaces of said base and finger portions forming a first elongated channel with an open end opposite to said base portion and adapted to receive the edge of the wall with said inner surface of said base portion engaging the exposed edge and said inner surfaces of said finger portions engaging marginal section of the wall directly adjacent thereto;
said method comprising the steps of:
providing the grommet strip with said length L greater by a length L than the total length of the exposed wall edge defining the opening in the wall; and
said grommet strip over the exposed edge with a first portion of said base portion of length overlaying the edge and said finger portions engaging portions of the wall adjacent to the edge, and a second portion of said base portion of length L overlapping a portion of said first portion at one end thereof.

14. A method according to claim 13 wherein said grommet strip includes a resilient non metallic coating covering outer surface portions of said base and finger portions; and
a resilient cushion strip of said length, and defining a second elongated channel retaining the elongated base portion and extending from one end of said spring tempered metal strip to a point spaced from an opposite end thereof by said length L and that portion of said grommet strip extending between said point and said opposite end disposed in a portion of said first elongated channel directly adjacent to said one end.

15. A grommet strip according to claim 14 wherein L is less than 5% of L.

16. A grommet strip according to claim 15 wherein said finger portions extending from one of said edges are longitudinally displaced with respect to said finger portions extending from the other of said edges so as to be transversely non aligned therewith.

17. A grommet strip according to claim 16 wherein each of said finger portions comprises a bottom edge fixed to one of said longitudinal edges, a top edge substantially shorter than said bottom edge, and side edges that project into said first elongated channel between said bottom and top edges.

18. A grommet strip according to claim 17 wherein said grommet strip has a uniform given height, and said cushion strip has a uniform predetermined height less than one-third (⅓) said given height.

19. A grommet strip according to claim 18 wherein said finger portions extending from one of said edges are longitudinally displaced with respect to said finger portions extending from the other of said edges so as to be transversely non aligned therewith.

20. A grommet strip according to claim 19 wherein each of said finger portions comprises a bottom edge fixed to one of said longitudinal edges, a top edge substantially shorter than said bottom edge, and side edges that project into said first elongated channel between said bottom and top edges.
